(19) United States
(12) Patent Application Publication
(10) Pub. No.: US 2004/0028340 A1
(43) Pub. Date: Feb. 12, 2004

(54) Optical connector component, its die structure, and manufacturing method

(76) Inventors: Yoshimasa Hiruma, Tokyo (JP); Akira kato, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/398,811

(22) PCT Filed: Oct. 12, 2001
(86) PCT No.: PCT/JP01/08987

(30) Foreign Application Priority Data
Oct. 13, 2000 (JP) 2000-314365

(51) Int. Cl. G02B 6/40

(52) U.S. Cl. 385/54

(57) ABSTRACT

An optical connector component of a sleeve, a ferrule, conversion sleeve, and an optical composite component which is manufactured precisely and easily at a low cost and improved in the decrease of a drawing force due to changes with time or friction. An optical connector component consisting of a thermoplastic resin and comprising a through hole for attaching an optical component, wherein grooves in a number of n (n is an integer of two or more) are arranged in parallel with the through hole in the outer surface or the inner surface at a position of n-times rotational symmetry on the axis of the center of the through hole.

### TECHNICAL FIELD

The invention of the present application relates to an optical connector component, its die structure and a manufacturing method. More specifically, the invention of the present application relates td an optical connector component of a sleeve, a ferrule, a conversion sleeve, and an optical composite component to be manufactured precisely and easily at a low cost, with reduction of the drawing force derived from the shape change by aging or wear improved. Moreover, a mold structure for manufacturing the optical connector component by injection molding, and a manufacturing method are also provided.

### BACKGROUND ART

Recently, various kinds of communication demand have dramatically been increased. Particularly in the field of the optical communication, the FTTH project of connecting optical fibers even to common families has been promoted. In order to establish the optical network extended to the details in a wide range economically, manufacture of various kinds of optical components at a low cost is required so that a large number of optical components have been made of plastics already. Also as to the sleeves and the ferrules used by a large quantity in the optical network, achievement of a low cost thereof is expected.

An optical connector is a component for detachably connecting optical fibers with each other, which connects ferrules with an optical fiber supported and fixed facing with each other in a cylindrical sleeve highly precisely by a 1 μm or less coaxiality allowance error. The optical connector sleeve in general is manufactured with a spring material of a zirconia ceramic, a stainless steel, a phosphor bronze, or the like, and the optical connector ferrule is manufactured with a zirconia ceramic, a glass or a precious stone as the material. However, these materials themselves are expensive. Moreover, too much manufacturing cost has been burdened for applying the above-mentioned precise process. Therefore, conventionally, manufacture of the optical connector sleeve and the optical connector ferrule with an inexpensive plastic has been attempted.

However, according to the plastic optical connector sleeve and optical connector ferrule, a problem is involved in that the drawing force is reduced due to generation of the size change, the wear, or the like generated according to increase of the number of detaching operations and the years of use.

Accordingly, the invention of the present application has been achieved in view of the above-mentioned circumstances, and an object thereof is to solve the problems in the conventional t chnique and to provide an optical connector component of a sleeve, a ferrule, a conversion sleeve, and an optical composite component to be manufactured precisely and easily at a low cost, with reduction of the drawing force derived from the shape change by aging or wear improved.

### DISCLOSURE OF THE INVENTION

Then, the invention of the present application provides the following inventions as those capable of solving the above-mentioned problems.

That is, firstly, the invention of the present application provides an optical connector component made of a thermoplastic resin having a through hole for mounting an optical component such as an optical fiber, wherein n sets (n is an integer of two or more) of grooves are provided parallel to the through hole on the outer surface or the outer surface of the optical connector component at a position of n-times rotational symmetry with the center of the through hole provided as the axis.

Then, the invention of the present application provides secondly an optical connector component wherein the optical connector component in the above-mentioned first invention is a ferrule for holding and fixing an optical component, thirdly an optical connector component wherein the optical connector component is a sleeve for bonding and holding a ferrule, fourthly an optical connector component wherein the optical connector component is a conversion sleeve having two through holes with different diameters on the same axis for bonding and holding ferrules with different diameters, and fifthly an optical connector component wherein the optical connector component is a ferrule-sleeve composite component for bonding and holding a ferrule and a sleeve on the same axis.

Then, the invention of the present application provides sixthly, an optical connector component wherein the groove has a 0.1 to 0.8 mm width and the wall thickness of the ferrule groove part has a 0.1 to 0.5 mm depth in the above-mentioned invention, seventhly, an optical connector component wherein the groove has a 0.1 to 0.8 mm width and the wall thickness of the ferrule groove part has a 0.01 to 0.5 mm depth, eighthly, an optical connector component wherein a degassing through hole is provided in the pipe wall corresponding to the bonding position of the optical component or the ferrule to be bonded and supported, ninthly, an optical connector component wherein the degassing through hole is provided by one or two at positions facing with each other, and tenthly, an optical connector component wherein the degassing through hole is 0.8 mm or less.

Furthermore, the invention of the present application provides eleventhly, a die structure for an optical connector component, for manufacturing the optical connector component according to any of the above-mentioned by injection molding, comprising one or more sets of cavities for forming the outer shap of the optical connector component and through hole forming pins as the core, wherein n sets (n is an integer of two or more) of groove forming projecting parts are provided parallel to the axis on the inner surface of the cavities or the outer surface of the through hole forming pins at a position of n-times rotational symmetry with the center of the optical connector component to be manufactured provided as the axis, twelfthly, a die structure for an optical connector component comprising one or more sets of cavities for forming the outer shape of the optical connector component, through hole forming pins and degassing through hole pins, wherein pin holes to be matched with the degassing through hole pins are formed from the outside of the die to the cavities, and the degassing through hole pins are fixed on the die in the state that the tip end is projected into the cavity inside space at the pin holes by a coil spring and a stopping tool so as to be contacted with the through hole forming pins provided in the inside of the cavities by a certain pressure by the coil spring, and thirteenthly, a die structure for an optical connector component wherein the cross-sectional shape of a gate provided in the die is ring-like, with the center thereof coinciding with the center of the cavities and the through hole forming pins, and the inner diameter thereof larger than the diameter of the through hole forming pins and the outer diameter thereof smaller than the cavities or the vertex part of the groove forming projecting parts provided on the inner surface of th cavities.

Additionally, fourteenthly, the invention of the present application provides a manufacturing method for an optical connector component wherein injection molding is executed using the die having the structure as mentioned above.

### BRIEF DESCRIPTION OF THE DRAWINGS

FIG. 1 is a diagram schematically showing an example of a ferrule-sleeve composite component according to the invention of the present application.

FIG. 2 is a diagram showing an example of a conversion sleeve according to the invention of the present application manufactured in an embodiment.

FIG. 3 is a diagram showing an example of a conversion sleeve according to the invention of the present application manufactured in the embodiment.

FIG. 4 is a diagram schematically showing an example of a ferrule of the invention of the present application.

FIG. 5 is a principal part vertical cross-sectional schematic diagram showing an example of a die structure of an optical connector component of the invention of the present application.

FIG. 6 is a principal part lateral cross-sectional schematic diagram showing an example of a die structure of an optical connector component of the invention of the present application.

FIG. 7 is a diagram showing a ferrule of the invention of the present application manufactured in an embodiment.

FIG. 8 is a diagram showing an example of results of analysis of the shape change of a ferrule of the invention of the present application in an embodiment by the finite element method.

FIG. 9 is a diagram showing an example of results of analysis of the shape change of a sleeve of the invention of the present application in an embodiment by the finite element method.

FIG. 10 is a graph showing an example of results of measurement of the optical axis displacement at the time of using a ferrule and a sleeve of the invention of the present application in an embodiment.

### BEST MODE FOR CARRYING OUT THE INVENTION

The invention of the present application has the above-mentioned characteristics, and embodiments thereof will be explained hereafter.

First, an optical connector component provided by the invention of the present application is made of a thermoplastic resin having a throughhole for mounting an optical component, wherein n sets (n is an integer of two or more) of grooves are provided parallel to the through hole on the outer surface or the inner surface of the optical connector component at a position of n-times rotational symmetry with the center of the through hole provided as the axis. As such an optical connector component, for example, various kinds of those comprising a through hole for mounting an optical component, such as a ferrule, a sleeve, a conversion sle ve and a ferrule-sleeve composite component can be considered.

Specifically, a ferrule is for holding and fixing an optical fiber. It is used for example by providing a through hole with a diameter to be matched with the optical fiber in the center thereof, inserting the optical fiber into the through hole so as to be fixed with an adhesive, or the like and polishing the tip end part thereof. As the through hole, one having a constant diameter, one having the diameter of the inserting part expanded for facilitating the optical fiber mounting operation, or the like can be considered.

Moreover, a sleeve is for realizing the optical coupling of the optical fibers by holding ferrules holding optical fibers on the same axis by providing a through hole with a diameter to be matched with the ferrule in the center thereof, inserting two ferrules each from the both ends of the through hole for bonding the same, and fixing the ferruled without displacement.

According to these ferrules and sleeves, detachment with each other should be facilitated as well as a high bonding accuracy should be ensured. Therefore, various types including a SC (Single Coupling) type, an MU (Miniature Unit coupling) type, or the like are provided.

Although the above-mentioned ferrule, sleeve and conversion sleeve has conventionally been used widely and commonly as the optical connector components, the ferrule-sleeve composite component can be realized for th first time by the invention of the present application.

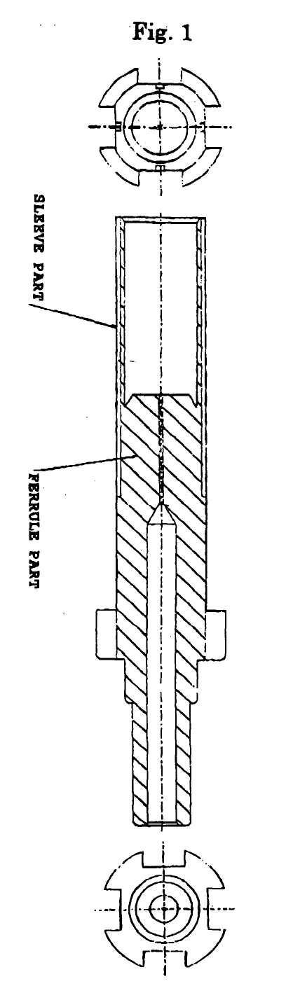

FIG. 1 is a conceptual diagram of a ferrule-sleeve composite component of the invention of the present application. That is, the ferrule-sleeve composite component provided by the invention of the present application has a form with the sleeve bonded to one end of the sleeve concentrically, for realizing the optical coupling of the optical fibers by inserting an optical fiber to a through hole in the axis part of the ferrule-sleeve composite component form the ferrule side so as to be held and fixed, and mounting a ferrule preliminarily holding and fixing an-optical fiber from the other end on the sleeve side.

As to the above-mentioned optical connector component of the invention of the present application, n sets (n is an integer of two or more) of grooves are provided on the outer surface or the inner surface thereof. Here, the inner surface denotes the surface of the through hole.

The grooves are provided from one end to the other end of the optical connector component, or a part thereof, parallel to the through hole at a position of n-times rotational symmetry with the center of the through hole provided as the axis. Then times rotational symmetry refers to the symmetry of for example a graphic rotated by each 360/n° with the axis as the center so as to be always identical to the original graphic. Then, the n-times rotational symmetry position refers to the dot group having the symmetry of the n-times rotational symmetry around a point. Specifically, it coincides with the v rtexes of a regular polygon with n angles.

As the groove shap, grooves having a substantially U-shape, a U shape, or the like can be considered. The width thereof can be set in a range of 0.1 to 0.8 mm. As to the depth, in the case the optical connector component is a ferrule or a ferrule part of a ferrule-sleeve composite component, the wall thickness of the groove part can be set at 0.1 to 0.5 mm, and in the case the optical connector component is a sleeve, a conversion sleeve or a sleeve part of a ferrule-sleeve composite component, the wall thickness of the groove part can be set at 0.01 to 0.5 mm.

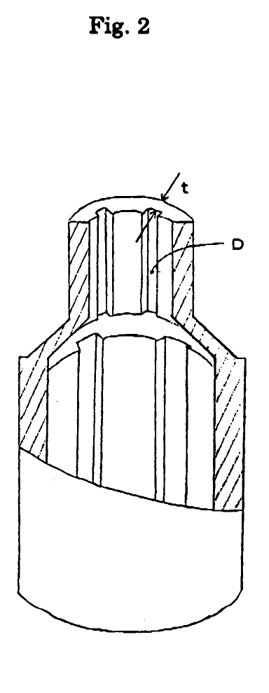

The wall thickness of the groove part here refers to, for example in the case of the conversion sleeve having a groove (D) in the inner surface as shown in FIG. 2, the thickness: t of the part provided with the groove.

The groove is for providing a spring property to the optical connector component like a split groove in a metal sleeve. It is for providing the function of alleviating the bending loss (distortion loss) generated by the excessive stress applied at the time the optical connector component adheres or fixes another optical component. As to the optical connector components made of a thermoplastic resin, one having the function of alleviating the bending loss has not been known so far, and it is realized for the first time by the invention of the present application. The groove formation is important in particular in the sleeve part. As mentioned above, an extremely thin wall thickness in a range of 0.01 to 0.5 mm is set.

By providing the groove, th optical connector component of the invention of the present application can be deformed well balanced and softly even in the case a local force is applied so that detachment with each other can be facilitated. Moreover, since the optical connector component of the invention of the present application comprises such a groove, size change, wear, or the like, which are problematic in the optical components made of a thermoplastic resin can be prevented so that even in the case the number of detaching operations and the years of use are increased, decline of the drawing force can hardly be generated.

Moreover, as the optical connector component of the invention of the present application, one provided with a degassing through hole perpendicular to the through hole axis in the pipe wall corresponding to the bonding position of the optical component or the ferrule to be bonded and supported can be considered. For example, in the case the optical connector component is a sleeve having a groove on the outer surface, the inner surface of the sleeve and the outer surface of the ferrule are supported in the extremely adhered state. Therefore, in the case the ferrules are inserted from the both ends of the sleeve, air is sealed in the sleeve so that the connection loss is generated due to the compressed air layer formed in the ferrule bonding part. Then, by providing the degassing through hole in the pipe wall of the optical connector compon nt corresponding to the ferrule bonding part, highly accurate bonding of the ferrules can be realized without formation of the air layer.

The degassing through hole may be provided by one at one point on the circumference of the pipe wall of the optical connector component corresponding to the bonding position of the optical component or the ferrule, or provided by two at positions facing with each other on the circumference. The two degassing through holes are sufficient, and thus it is not preferable to provide the same by three or more in terms of the strength and maintenance of the accuracy. Moreover, from the same reason, it is preferable to provide the diameter of the degassing through hole by 0.8 mm or less.

In the above-mentioned optical connector component, inverted clearance design of about −1/100 to 0 mm of the outer diameter of the ferrule and the inner diameter of the sleeve, the conversion sleeve, or the ferrule-sleeve composite component can be enabled so that they can be separated by a preset drawing force. Therefore, the sleeve, the conversion sleeve or the ferrule-sleeve composite component, and the ferrule can easily be detached with each other as well as a high bonding accuracy can be ensured.

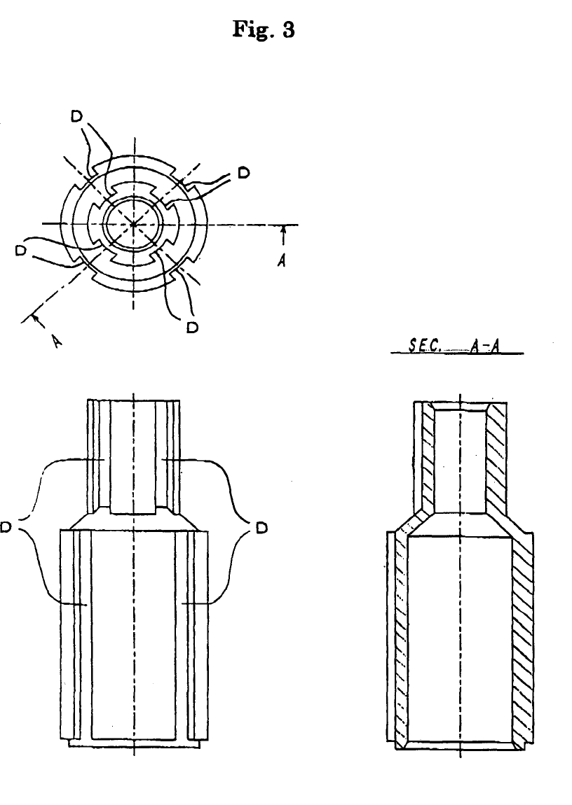

Moreover, the shape of the optical connector component itself, in particular, the shape of the ferrule, the conversion sleeve and the ferrule-sleeve composite component can be a complicated shape having the ruggedness such as a projection on the surface in most cases. In this case, a groove needs not be continuous but it may be divided into several parts. For example, an upper view, a side view and an A-A cross-sectional view of a conversion sleeve provided with four grooves (D) on the outer surface are shown in FIG. 3 as an example. The conversion sleeve in this embodiment is a conversion sleeve for bonding ferrules of φ 2.5 mm and φ 1.25 mm, with the shape with two cylinders having a 0.65 mm wall thickness, a 2.499 mm inner diameter and a 1.249 mm inner diameter bonded smoothly by a 45° inclined surface (a conical oblique surface having a 90° vertex angle). Then, on the outer surface thereof, for example, grooves with a 0.6 mm width and a 0.2 mm depth are provided per 360/4=90° with respect to the central axis. As shown in the figure, a groove needs not be continuous. For example, the oblique surface part needs not be provided with a groove.

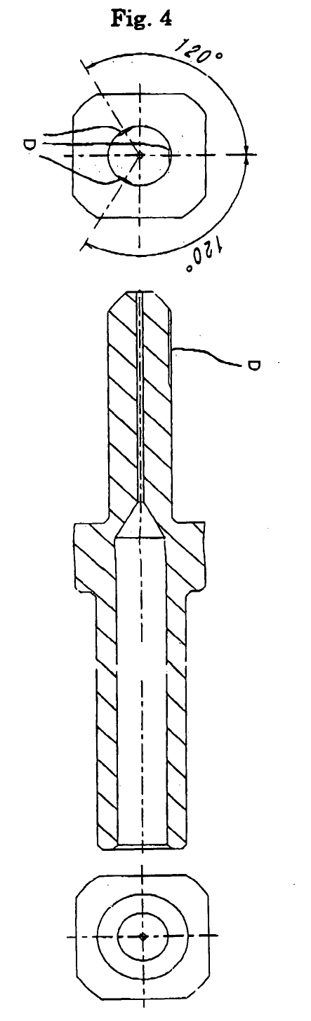

Moreover, a side view and a vertical cross-sectional view of a ferrule provided with three grooves (D) on the outer surface are shown in FIG. 4 as an example. The ferrule in this embodiment does not have a constant through hole diameter, and it comprises a part having a minute through hole for holding and fixing an optical fiber and a part having a large through hole for facilitating attachment of an optical fiber. In this case, in order to effectively provide the spring property to the ferrule, for example, a groove can be provided to the outer surface of the part having a minute through hole. Furthermore, by controlling the width and the depth, or the like of the groove, as shown in the figure, it is also possible to provide a groove only on the outer surface corresponding to a part having a minute through hole, that is, to shorten the length of the groove. Of course, it is needless to say that the groove can be provided from one end of the ferrule to the other end.

According to the optical connector component of the invention of the present application, by using a thermoplastic resin as the material, a low cost of the material cost can be achieved. As the thermoplastic resin, it is preferable to use various kinds of liquid crystal polymers to be processed precisely owing to the good orientation characteristics without generating a gas at the time of molding. As the liquid crystal polymer, there are a solution type liquid crystal (lyotropic liquid crystal) showing the liquid crystal property in a solution state and a molten type liquid crystal (thermotropic liquid crystal) showing the liquid crystal property in a molten state as a large classification. According to the invention of the present application, it is preferable to use a thermotropic liquid crystal polymer such as a liquid crystal polyester and a liquid crystal polyester imide. Specifically, a (all) aromatic polyester, a polyester amide, a polyester carbonate, or the like can be presented. It is preferably a liquid crystal polyester. As long as one includes a plurality of ester bonds in a molecule, it is included in a polyester. A preferable polyester is an aromatic polyester.

As a manufacturing method for an optical connector component of the invention of the present application as mentioned above, an injection molding m thod, a compression method, a casting method, or the like can be used. In particular, in order to manufacture a long and delicate through hole, a groove characteristic of the invention of the present application, and furthermore, an optical connector component having a complicated shape precisely with high efficiency, it is preferable to use the injection molding method.

As a die structure for manufacturing the optical connector component by the injection molding, a die structure for an optical connector component comprising one or more sets of cavities for forming the outer shape of the optical connector component and through hole forming pins as the core, wherein n sets (n is an integer of two or more) of groove forming projecting parts are provided parallel to the axis on the inner surface of the cavities or the outer surface of the through hole forming pins at a position of n-times rotational symmetry with the center of the optical connector component to be manufactured provided as the axis can be considered. As the cross-sectional shape of the groove forming projecting parts characteristic of the die, a projecting part of a quadrilateral shape, an arc-like shape, or the like for forming a groove of a substantially U shape, a U shape, or the like can be considered. The width thereof is preferably in a range of 0.1 to 0.8 mm. Moreover, as to the height, it is preferable to design such that the distance between the v rtex part of the groove forming projecting parts and the through hole forming pins as the core, that is, the wall thickness of the rear part of the optical connector component to be manufactured is 0.01 to 0.5 mm. Such a die structure of the invention of the present application may be for example a one stage sprue die, or a two stage sprue die preferable for manufacturing a large number of optical connector components at one time. Moreover, it is also possible to provide a die as a dividable type comprising a several blocks depending on the shape of the optical connector component, the number and the position of the grooves, or the like, utilizing a conventional die designing technique, or utilize an undercut technique.

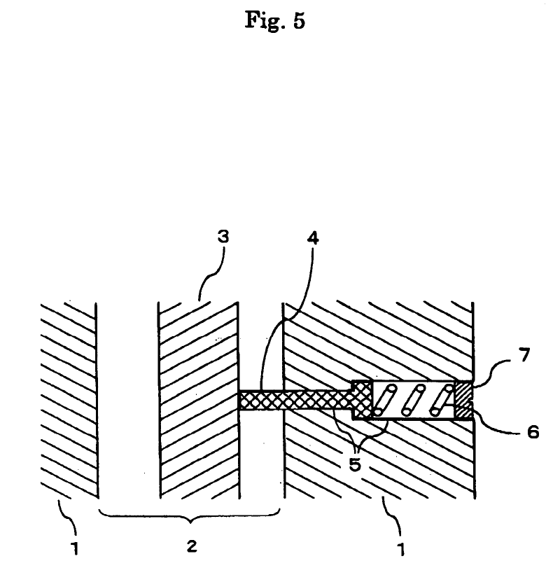

Moreover, in the case a degassing through hole is provided in the optical connector component, use of the die structure of the invention of the present application can be presented as a preferable example. For example, FIG. 5 shows an example of a principal part cross-sectional view of a die structure of the invention of the present application. The die (1) comprises one or more sets of degassing through hole pins (4) in addition to cavities (2) and through hole forming pins (3) for forming the outer shape of the above-mentioned optical connector. Pin holes (5) to be matched with the degassing through hole pins (4) are formed form the outside of the die to the cavities (2). The degassing through hole pins (4) are fixed on the die (1) in the state that the tip end is projected into the cavity (2) inside space at the pin holes (5) by a coil spring (6) and a stopping tool (7) so as to be contacted with the through hole forming pins (3) provided in the inside of the cavities (2) by a certain pressure by the coil spring (6). It is appropriate that the compression force of the coil spring (6) is provided by about 2 to 3 kg. According to that, adjustment of the butting strength of the degassing through hole pins (4) to the through hole forming pins (3) can be facilitated. So that damage of the through hole forming pins (3) or the degassing through hole pins (4) due to strong butting can be prevented.

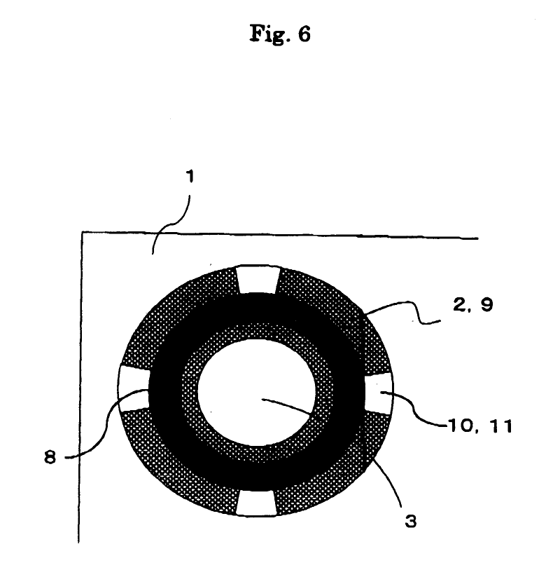

Moreover, the die is provided with a sprue, a runner and a gate for the resin inlet path. An example of a lateral cross-sectional shape of the gate part of the die structure provided by the invention of the present application is shown in FIG. 6.

According to the invention of the present application, it is preferable that the cross-sectional shape of the gate (8) provided in the die (1) is ring-like, with the center thereof coinciding with the center of the cavity (2) and the through hole forming pin (3), the inner diameter there of is larger than the diameter of the through hole forming pin (3), and the outer diameter is made smaller than the cavity (2) or the vertex part of the groove forming projecting part (10) provided on the inner surface of the cavity (2). That is, as shown in FIG. 6, for example, in the case a groove (11) is formed in the outer circumferential part of the optical connector component (9) to be manufactured, the gate (8) is provided so as to be stored in the wall thickness of the optical connector component (9) in the cross-section. By providing the gate (8) shape like a pipe, generation of the weld line to be the critical defect of causing the strength deterioration can be prevented so that the optical connector component (9) as a high quality molded product can be obtained.

According to the injection molding using the die structure of the invention of the present application mentioned above, an optical connector component for a sleeve, a ferrule, a conversion sleeve and an optical connector composite component with the decline of the drawing force due to the change by aging and the wear improved can be manufactured precisely and easily at a low cost.

Hereinafter, the examples will be described and the embodiments of the invention of the present application will be described further in detail.

### EXAMPLES

### Example 1

Using a liquid crystal polymer, a conversion sleeve as an optical connector component of the invention of the present application was manufactured by the injection molding method. A schematic diagram of the obtained conversion sleeve is shown in FIG. 3. The conversion sleeve is provided with a minute hole having a 2.499 mm inner diameter and a minute hole having a 1.249 mm inner diameter on the same axis, with the bonding part of the minute holes having an inclined and smoothly connected shape. Four grooves (D) having a 0.6 mm width and a 0.2 mm depth are provided parallel to the axis on the outer surface of the conversion sleeve.

Two optical fibers of φ 2.5 mm and φ 1.25 mm were bonded by the conversion sleeve so as to obtain a connection loss within 0.5 dB.

### Example 2

Using a liquid crystal polymer, a conversion sleeve as an optical connector component of the invention of the present application was manufactured by the injection molding method. A schematic diagram of the obtained conversion sleeve is shown in FIG. 2. The conversion sleeve in provided with a minute hole having a 2.499 mm inner diameter and a minute hole having a 1.249 mm inner diameter on the same axis, with the bonding part of the minute holes having an inclined and smoothly connected shape. Four grooves (D) having a 0.6 mm width and a 0.2 mm depth are provided parallel to the axis on the inner surface of the conversion sleeve.

Two ferrules of φ 2.5 mm and φ 1.25 mm were bonded by the conversion sleeve so as to obtain a connection loss within 0.5 dB.

### Example 3

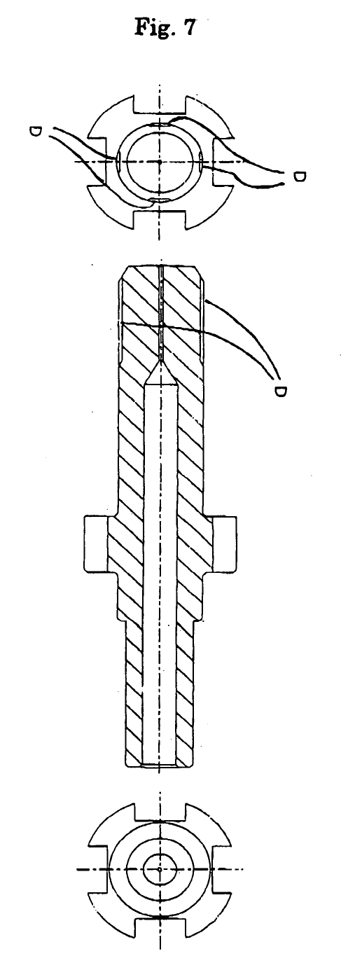

Using a liquid crystal polymer, a ferrule as an optical connector component of the invention of the present application was manufactured by the injection molding method. A schematic diagram of the obtained ferrule is shown in FIG. 7. The ferrule is provided with a through hole having a 2.499 mm inner diameter, with four grooves (D) having a 0.8 mm width and a 0.5 mm depth provided parallel to the axis on the outer surface thereof.

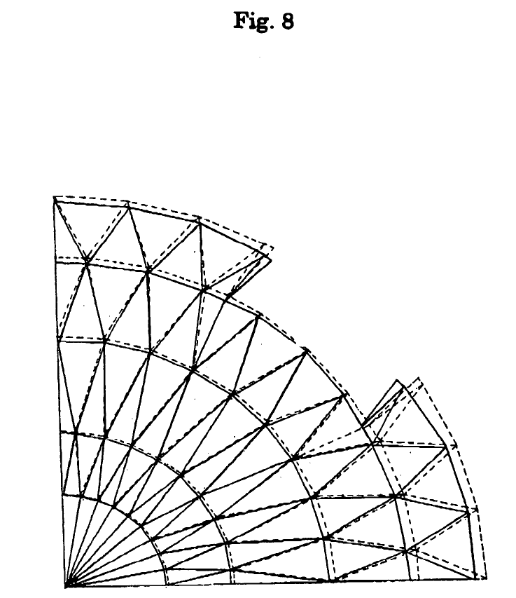

Theoretical analysis by the finite element method was executed for finding out the ferrule shape change at the time of applying an inserting force and a drawing force. Results thereof are shown in FIG. 8. From FIG. 8, it is shown that a spring property is provided by providing the grooves in the ferrule of the invention of the present application so that the ferrule can be deformed smoothly at the time the inserting force and the drawing force are applied.

### Example 4

In the same manner as in the example 3, a sleeve as an optical connector component of the invention of the present application was manufactured. The sleeve is provided with a through hole having a 2.499 mm inner diameter, with four grooves (D) having a 0.8 mm width and a 0.5 mm depth provided parallel to the axis on the outer surface thereof.

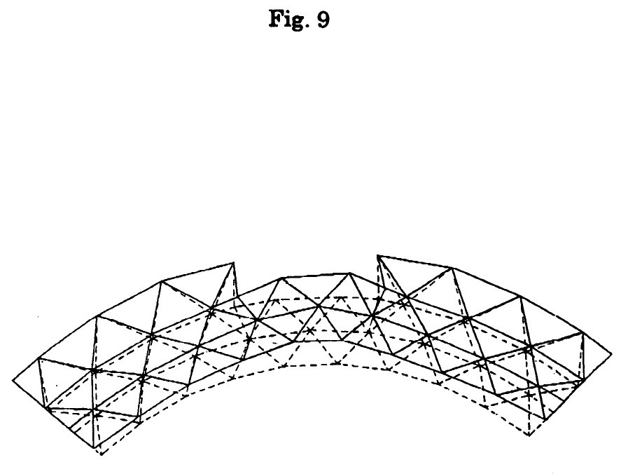

Theoretical analysis by the finite element method was executed for finding out the sleeve shape change at the time of applying an inserting force and a drawing force. Results thereof are shown in FIG. 9. From FIG. 9, it is shown that a spring property is provided by providing the grooves in the sleeve of the invention of the present application so that the sleeve can be deformed smoothly at the time the inserting force and the drawing force are applied.

### Example 5

Using a liquid crystal polym r, a ferrule as an optical connector component of the invention of the present application was manufactured by th injection m lding method. The ferrule is provided with five grooves having a 0.8 mm width and a 0.5 mm depth parallel to the axis each by 360/5=72° on the outer surface thereof.

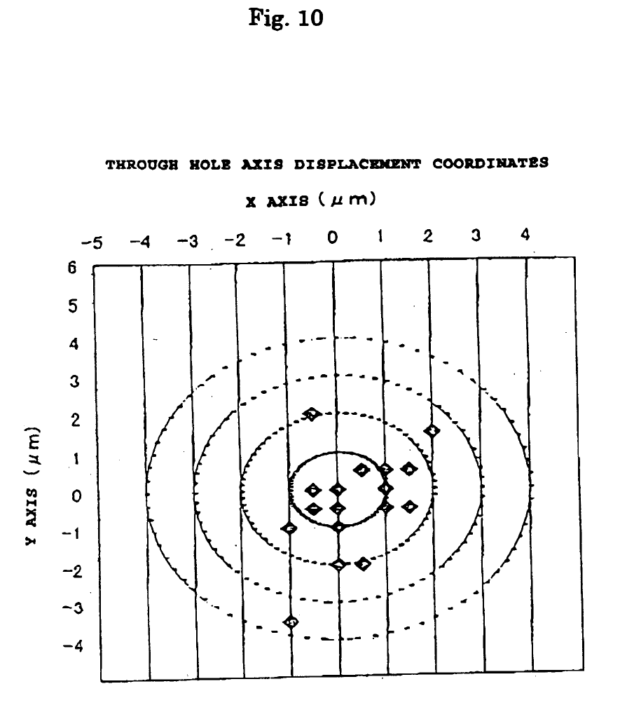

Using the ferrule and two pieces of the sleeves manufactured in the example 4, two optical fibers were bonded and the optical axis displacement was measured. Results thereof are shown in FIG. 10. According to the ferrule and the sleeves, highly precise bonding of about 7/10,000 mm was enabled.

Of course it is needless to say that the invention of the present application is not limited to the above-mentioned embodiments, and various embodiments can be adopted for the details.

### INDUSTRIAL APPLICABILITY

As heretofore explained in detail, according to the invention of the present application, an optical connector component of a sleeve, a ferrule, a conversion sleeve, and an optical composite component to be manufactured precisely and easily at a low cost, with reduction of the drawing force derived from the shape change by aging or wear improved, can be provided.

1. An optical connector component made of a thermoplastic resin having a through hole for mounting an optical component, wherein n sets (n is an integer of two or more) of grooves are provided parallel to the through hole on the outer surface or the inner surface of the optical connector component at a position of n-times rotational symmetry with the center of the through hole provided as the axis.

2. The optical connector component according to claim 1, wherein the optical connector component is a ferrule for holding and fixing an optical component.

3. The optical connector component according to claim 1, wherein the optical connector component is a sleeve for bonding and holding a ferrule.

4. The optical connector component according to claim 1, wherein the optical connector component is a conversion sleeve having two through holes with different diameters on the same axis for bonding and holding ferrules with different diameters.

5. The optical connector component according to claim 1, wherein the optical connector component is a ferrule-sleeve composite component for bonding and holding a ferrule and a sleeve on the same axis.

6. The optical connector component according to any one of claims 1 to 5, wherein the groove has a 0.1 to 0.8 mm width and the wall thickness of the ferrule groove part has a 0.1 to 0.5 mm depth.

7. The optical connector component according to any one of claims 1 to 5, wherein the groove has a 0.1 to 0.8 mm width and the wall thickness of the ferrule groove part has a 0.01 to 0.5 mm depth.

8. The optical connector component according to any one of claims 3 to 8, wherein a degassing through hole is provided in the pipe wall corresponding to the bonding position of the optical component or the ferrule to be bonded and supported.

9. The optical connector component according to claim 8, wherein the degassing through hole is provided by one or two at positions facing with each other.

10. The optical connector component according to claim 8 or 9, wherein the degassing through hole is 0.8 mm or less.

11. A die structure for an optical connector component, for manufacturing the optical connector component according to any one of claims 1 to 10 by injection molding, comprising one or more sets of cavities for forming the outer shape of the optical connector component and through hole forming pins as the core, wherein n sets (n is an integer of two or more) of groove forming projecting parts are provided parallel to the axis on the inner surface of the cavities or the outer surface of the through hole forming pins at a position of n-times rotational symmetry with the center of the optical connector component to be manufactured provided as the axis.

12. The die structure for an optical connector component according to claim 11, comprising one or more sets of cavities for forming the outer shape of the optical connector component, through hole forming pins and degassing through hole pins, wherein pin holes to be matched with the degassing through hole pins are formed from the outside of the die to the cavities, and the degassing through hole pins are fixed on the die in the state that the tip end is projected into the cavity inside space at the pin holes by a coil spring and a stopping tool so as to be contacted with the through hole forming pins provided in the inside of the cavities by a certain pressure by the coil spring

13. The die structure for an optical connector component according to claim 11 or 12, wherein the cross-sectional shape of a gate provided in the die is ring-like, with the center thereof coinciding with the center of the cavities and the through hole forming pins, and the inner diameter thereof larger than the diameter of the through hole forming pins and the outer diameter thereof smaller than the cavities or the vertex part of the groove forming projecting parts provided on the inner surface of the cavities.

14. A manufacturing method for an optical connector component wherein injection molding is executed using the die having the structure according to any one of claims 11 to 13.
